(19) United States
(12) Patent Application Publication
(10) Pub. No.: US 2025/0048520 A1
(43) Pub. Date: Feb. 6, 2025

(54) HYBRID LED CONFIGURATION FOR EVEN ILLUMINATION, SYSTEM AND METHOD

(71) Applicant: Thomas Stack, Oxford, MI (US)

(72) Inventor: Thomas Stack, Oxford, MI (US)

(21) Appl. No.: 18/795,101

(22) Filed: Aug. 5, 2024

Related U.S. Application Data
(60) Provisional application No. 63/517,610, filed on Aug. 3, 2023.

(51) Int. Cl. H05B 47/155; F21K 9/69; F21S 4/20; F21Y 115/10; H05B 45/20

(52) U.S. Cl. CPC H05B 47/155; F21K 9/69; F21S 4/20; H05B 45/20; F21Y 2115/10

(57) ABSTRACT

A hybrid lighting system featuring two types of LEDs is disclosed. One set of LEDs with lenses exists at a particular position in relation to a fixture, with a second set optionally having lenses at a different position. Each set has separate optional current control which may be adjusted in relation to each other. Advantages of the system include more even color and brightness illumination while maintaining efficiency.

### BACKGROUND

The present development relates to various aspects of lighting systems. In particular, the present development relates to lighting systems and illumination of partially or fully or enclosed spaces such as product display cases, grocery canopy, and under-shelf lighting in various display appliances.

The use of fluorescent lamps and lighting technology is well known in the lighting art. However, disadvantages of a fluorescent lamp and its ballast include the emission of heat as a side effect, which is counterproductive for use with a cooling apparatus. Further, unsafe conditions may occur in a fluorescent lighting system, including the possibility of high voltage arcing, which could either directly harm the installer, customers, or bystanders, or indirectly by starting a fire. The use of mercury in a fluorescent lamp poses a health hazard to store employees, customers or final consumers due to accidental breakage of a lamp allowing the mercury to contaminate the cabinet interior or product surfaces. Finally, fluorescent bulbs have a limited lifetime, requiring inconvenient replacement.

Attempts have been made in the art toward energy efficient solid state lighting such as light emitting devices (LEDs). However, the existing lighting systems are wanting in aspects including, for example, structural shortcoming, lack of modularity, difficulty in manufacture, high costs of manufacture, lack of uniformity in illumination, or a combination of any of these and other deficiencies.

Accordingly, a need remains for an improved illumination system and technology to produce more uniform or controlled gradient illumination of substantially enclosed spaces.

Additional challenges exist in trying to produce a uniform light distribution using LEDs. Unlike fluorescent or incandescent bulbs, LEDs don't provide uniform output around 360 degrees.

FIG. 1A shows in cross section the angular distribution of a first example LED 105. The output including rays 110 is shown in 3-D conical format in FIG. 1B. A cross section with linear shading is shown to depict how the conical beam output makes a hyperbolic pattern 117. This is further shown in FIG. 1C. The intersection of a conical beam with a planar surface producing a hyperbola is well known in the art.

Sometimes the beam angle is intentionally reduced using a lens. However, a lens may absorb some of the light being emitted before it reaches the target area.

Another disadvantage of how some LEDs operate is their light output color may differ with spatial distribution. FIG. 2 shows a hypothetical color distribution from LED 110 with lens 112 that produces for example due to chromatic aberration a yellow color in the outlier region 122 while a closer to white color primarily exists at angles between the axis of emission 115 and the ray boundary 120. To help explain the prior art the color transition is shown as a black and white line border at ray 120, but the color transition is often more gradual than a drastic line crossing transition.

It should be noted that the lens 112 may be joined to LED 110 during the manufacturing process, or be mounted through use of an external structure (not shown in FIG. 2) that allows the light from LED 110 to shine through lens 112 with partial or no physical contact between LED 110 and lens 112.

FIG. 3A shows the output pattern as in FIG. 2, now with a surface 150 being present that the color fringed LED 110 and lens 112 shine on to. In this case, two projection zones result, a first zone 118 of primarily white light (which is within the angle θ1 relative to the center ray 115 and includes sample ray 117), and a second yellowish zone 124 produced by light emitted between angles θ1 and θ2 (symbolized by rays 120 and 125 respectively). Again, the actual color transition is often more gradual than a drastic line crossing transition at ray 120.

FIG. 3B shows the arrangement of FIG. 3A but at an angle perpendicular to the plane of surface 150. There is still a vertical separation 111 as shown in FIG. 3A. In this perspective the production of two hyperbolic projections result, a first zone 118 of primarily white light (which is within the angle θ1 relative to the center ray 115), and a second yellowish zone 124 produced by light emitted between angles θ1 and θ2. Solid line hyperbolic arcs 130 and 135 are used to show “fuzzy boundaries” where the dashed line rays 120 and 125 and other rays emitted between angles θ1 and θ2 make contact with surface 150.

With these concerns of uneven light and color from single LED and lens combinations, a need remains for producing even lighting from LED sources, while maintaining efficiency of electrical input to light output.

### SUMMARY

The need is met by the present development. To achieve this even distribution, the present development arranges varied LEDs in positions to balance light output and efficiency.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A through 1C show rays and geometry for an example LED output light distribution;

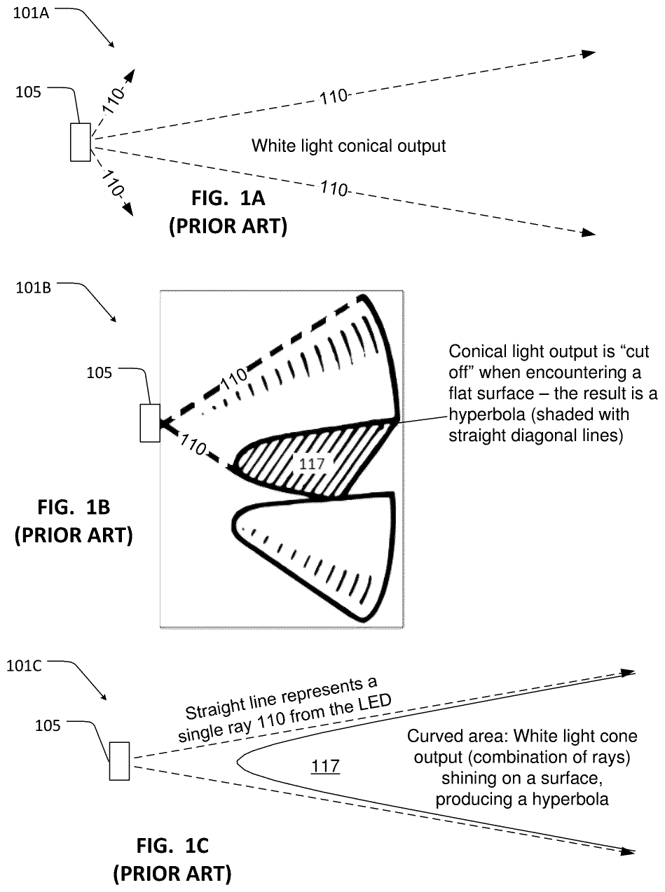

FIG. 2 shows output of multiple rays from a different example LED with a lens;

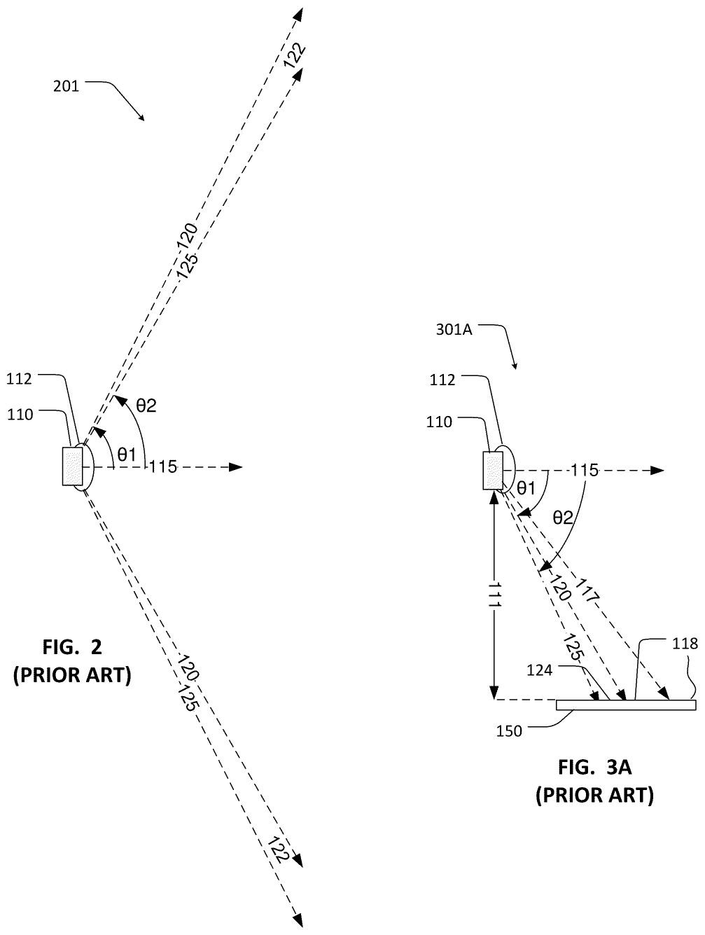

FIGS. 3A and 3B show output of multiple rays as in FIG. 2, and also projection zones onto a surface;

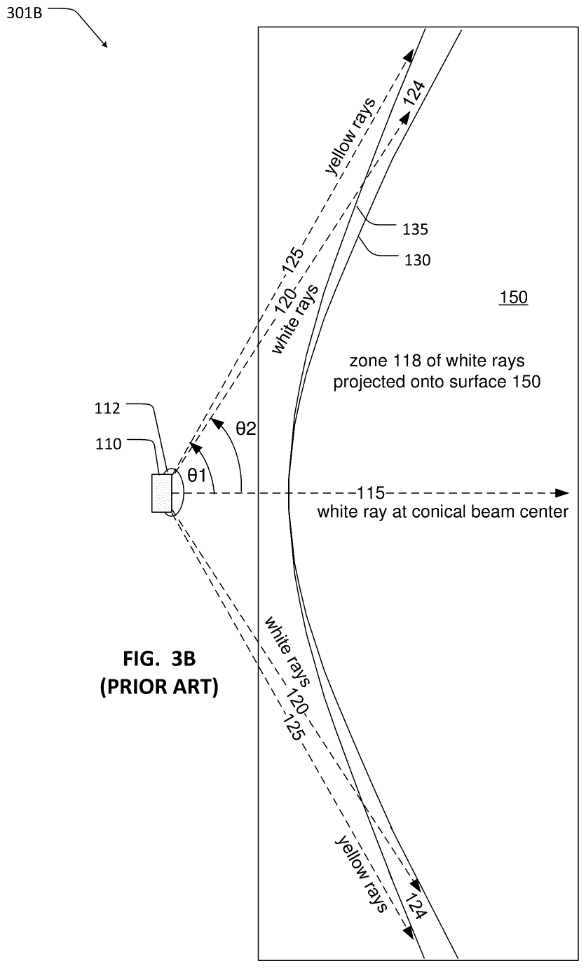

FIGS. 4A through 4C show top, front and side configurations of a lighting module,

FIGS. 5A through 5C show aspects of varying combining module light beam levels to produce more even illumination, and;

FIG. 6 shows a control system to adjust light output levels.

### DETAILED DESCRIPTION

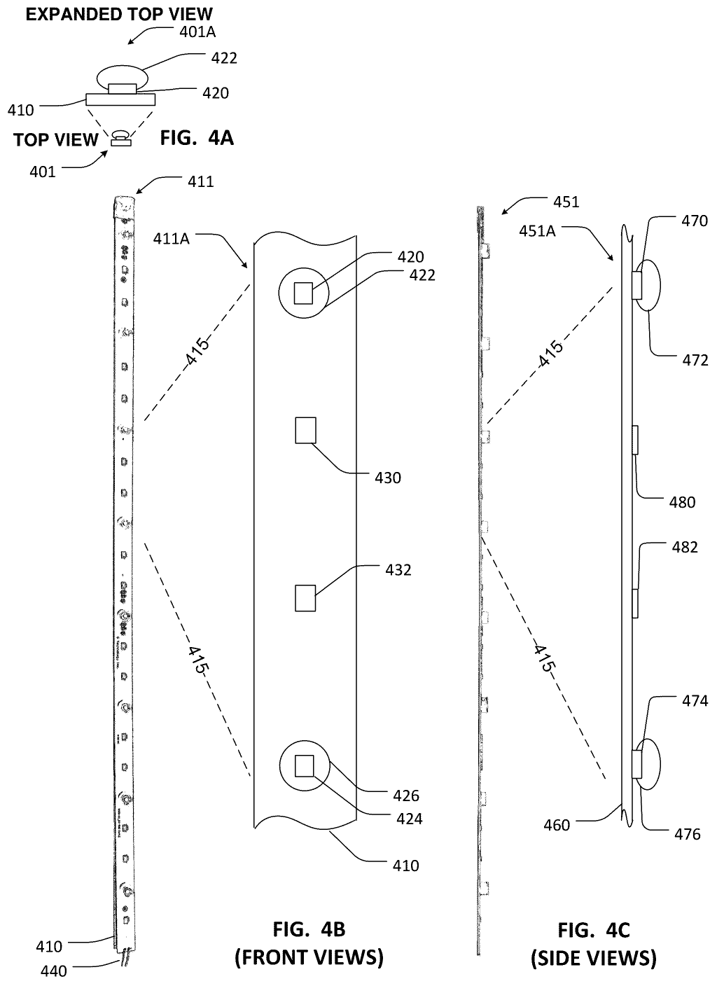

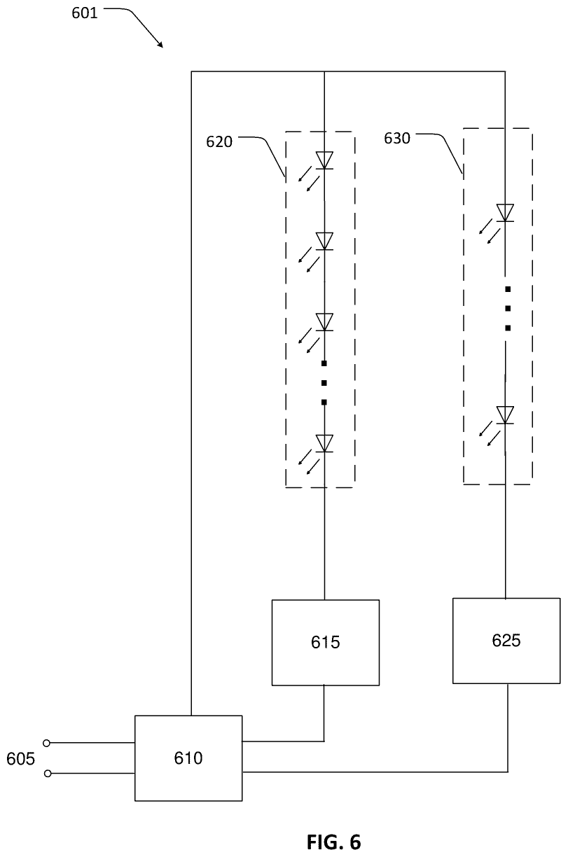

A lighting system will now be described with reference to FIGS. 4 through 6 which illustrate various aspects, embodiments, or implementations of the present invention. In the Figures, some sizes of structures, portions, or elements may be exaggerated relative to sizes of other structures, portions, or elements for illustrative purposes, and thus are provided to aid in the illustration and the disclosure of the present invention.

FIG. 4A shows a top perspective view of a lighting module according to one embodiment of the present invention.

The top view 401 is expanded (as implied with dashed lines) to a larger section 401A which shows a circuit board 410 along with rectangular LED 420 and lens 422. Actually, many LEDs exist along the length of module 401A, but the view is blocked by the LED 420 and lens 422 most closely facing the viewer in FIG. 4A.

FIG. 4B shows a front perspective view of this lighting module. The top view 411 is expanded (as implied with dashed lines 415) to a larger section 411A which shows a circuit board 410 along with rectangular LEDs 430 and 432, and square LEDs 420 and 424 having lenses 422 and 426 respectively.

FIG. 4C shows a module side view 451 that is likewise expanded to a larger section 451A which shows a circuit board 460 with rectangular LEDs 480 and 482, along with square LEDs 470 and 474 having lenses 472 and 476 respectively.

In this example, the square LED may be a type 3030 (dimensions 30 mm by 30 mm) at 5000K color temperature. The rectangular LED type may be type 2835 (dimensions 28 mm by 35 mm, also at 5000K color temperature). It is not considered essential to use these particular shapes or sizes but these configurations have been shown to work properly.

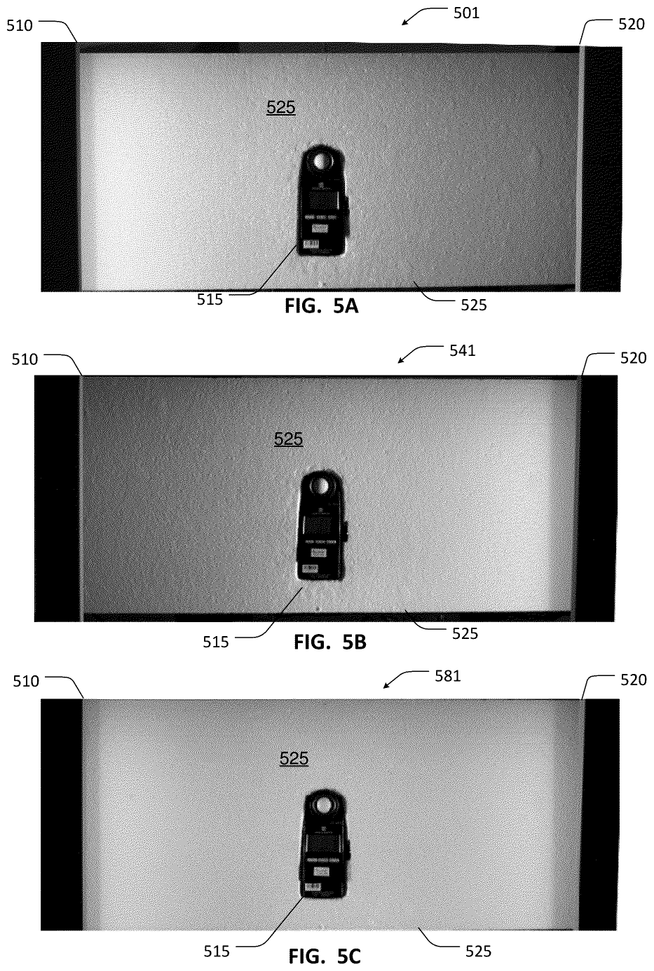

FIG. 5 shows various combinations of module output to produce a balanced lighting pattern.

The black borders to either side symbolize cabinet jambs which physically support the modules. The modules 510 and 520 are shown edge on (like the side view in FIG. 4C). These modules 510 and 520 shine on a surface 425.

Conceptually, FIG. 5A shows the left side module 510 lit up, while FIG. 5B shows the right side module 520 lit up.

FIG. 5C shows the combined result of both modules 510 and 520 lit up. As can be seen, the resulting illumination in FIG. 5C is mostly level and uniformly white in color.

The center object 515 in each photograph is a photometer, which is used to take measurements to confirm the lighting distribution.

The illumination zone between the two lighting modules 510 and 520 is produced by each module's combination of one set of LEDs (in this example, square LEDs with lenses) which emits a particular light pattern, and another set of LEDs (in this example rectangular LEDs) with a different set of emission properties, to collectively produce an even lighting pattern. Between the two, the light properties balance.

Adjustment of the relative lighting proportions may be performed using electronic control as shown in FIG. 5. The example simplified control module 610 which is powered at terminals 605 produces signaling to LED drivers 615 and 625 to drive LED strings 620 and 630. Through this means, brightness adjustment of one or both sets of LEDs may be performed to improve the relative lighting balance.

Control modules which are capable of adjusting LED brightness are well known in the art. Other means of relative light intensity adjustment are possible, for example through having tuned circuits which pass different amounts of current depending on frequency.

While the LEDs shown in strings 620 and 630 are symbolized with a polarity, it is also possible to use nonpolarized (AC) LEDs to carry out the intent of having relative color adjustment.

### CONCLUSIONS, RAMIFICATIONS, AND SCOPE

In the preferred configuration, a first set of LEDs transmits with a particular pattern of light output, and another set of LEDs transmit with a different pattern. From adjusting the power delivered to the two alternate configurations, the light and color intensity properties of each set can be made to balance into an essentially uniform output across a surface.

The example configuration involves each set of LEDs arranged in an equally spaced, linear pattern. Alternative configurations are possible which involve positioning balancing light from the yellow fringe region with light from the alternate set. Further while in this example the ratio of LEDs in the one set to the LEDs in the other set is 1:1, it has been found that set partitions which have a ratio of 2 lensed LEDs in the first set to 1 unlensed LED in the other set will also work.

Further adjustment of lighting properties is possible through using a combination of either reflectors or lenses or both to modify the color distribution being projected onto the surface to be illuminated.

To further tune the color distribution, a tinted stripe may be applied to a light transmissive fixture or made with a lens to filter yellow light closer to the fixture.

Alternatively, a blue or other color reflector may be applied to increase the amount and tune the color of light reaching the items to be illuminated.

From the foregoing, it will be appreciated that the present invention is novel and offers advantages over the current art. Although a specific embodiment of the invention is described and illustrated above, the invention is not to be limited to the specific forms or arrangements of parts so described and illustrated. For example, differing configurations, sizes, or materials may be used to practice the present invention. The invention is limited by the claims that follow.

What is claimed is:

1. A lighting system, comprising:
a first set of light sources, the light sources each producing a substantially conical lighting pattern, emitting an inner light cone having a first color spectrum,
and emitting an outer light cone having a second color spectrum;
a second set of light sources, the light sources each having the characteristic of producing a substantially conical lighting pattern, emitting at a third color spectrum;
with the first and second set of light sources being arranged to produce a substantially even lighting pattern distribution across a surface when powered.

2. A lighting system as in claim 1 wherein the light sources of each set are spaced along a straight line, each set spaced independently of the other.

3. A lighting system as in claim 1 wherein the first set of light sources is LEDs combined with lenses to reshape the output light pattern.

4. A lighting system as in claim 1 wherein electrical control is used to independently deliver power to the first set and second set.

5. A lighting system, comprising:
a first set of light sources, the light sources each producing a lighting pattern relative to a central axis,
emitting an inner light pattern at smaller angles relative to the axis,
said inner light pattern having a first color spectrum,
and emitting an outer light pattern at larger angles relative to the axis,
said outer light pattern having a second color spectrum;
a second set of light sources, the light sources each having the characteristic of producing a lighting pattern relative to an axis, emitting at a third color spectrum;
with the first and second set of light sources being arranged to produce a substantially even lighting pattern distribution across a surface when powered.

6. A lighting system as in claim 5 wherein the light sources of each set are spaced along a straight line, each set spaced independently of the other.

7. A lighting system as in claim 5 wherein the first set of light sources is LEDs combined with lenses to reshape the output light pattern.

8. A lighting system as in claim 5 wherein electrical control is used to independently deliver power to the first set and second set.
